(19) United States
(12) Patent Application Publication
(10) Pub. No.: US 2026/0302672 A1
(43) Pub. Date: Oct. 1, 2026

(54) Terminal and Connector

(71) Applicants: Tyco Electronics (Shanghai) Co., Ltd., Shanghai (CN); Tyco Electronics Technology (SIP) Co., Ltd., Suzhou (CN)

(72) Inventors: Yu (Shanks) Du, Suzhou (CN); Lei Pan, Shanghai (CN); Weidong Zhang, Shanghai (CN)

(73) Assignees: Tyco Electronics (Shanghai) Co., Ltd., Shanghai (CN); Tyco Electronics Technology (SIP) Co., Ltd., Suzhou (CN)

(21) Appl. No.: 19/578,988

(22) Filed: Mar. 26, 2026

(30) Foreign Application Priority Data
Mar. 26, 2025 (CN) 202520542628.8

(51) Int. Cl. H01R 13/11; H01R 13/05; H01R 13/26; H01R 13/432

(52) U.S. Cl. CPC H01R 13/113; H01R 13/055; H01R 13/26; H01R 13/432

(57) ABSTRACT

A terminal comprises a terminal shell and a terminal board. The terminal shell has a top wall and a bottom wall opposite each other in its height direction, and an elastic member located on the inner side of the top wall. The elastic member includes a pressing plate and multiple support arms connected to four edges of the pressing plate. The multiple support arms extend obliquely away from the pressing plate relative to the height direction, and are adapted to suspend the pressing plate on an inner side of the top wall. The terminal board has a front end fixed to the inner side of the bottom wall of the terminal shell and a contact protrusion formed on the front surface of its front end.

### CROSS-REFERENCE TO RELATED APPLICATION

This application claims the benefit of Chinese Patent Application No. CN 202520542628.8 filed on Mar. 26, 2025 in the State Intellectual Property Office of China, the whole disclosure of which is incorporated herein by reference.

### FIELD OF THE INVENTION

The disclosure relates to a terminal and a connector comprising the terminal.

### BACKGROUND OF THE INVENTION

In the prior art, in order to achieve electrical connection between a terminal and a mating terminal, an elastic cantilever is usually formed on the terminal, which makes electrical contact with the mating terminal through the elastic cantilever. However, the electrical contact of ordinary elastic cantilever is unreliable, especially in vibration environments, which can easily lead to unstable electrical contact.

In addition, in the prior art, the entire terminal is made of copper or copper alloy. This leads to a higher surface roughness of the terminal, increasing the friction between the terminal and the mating terminal, resulting in excessive insertion and extraction force of the terminal. In addition, the overall use of copper or copper alloy component for the terminal can also result in higher costs.

### SUMMARY OF THE INVENTION

According to an embodiment of the present disclosure, a terminal comprises a terminal shell and a terminal board. The terminal shell has a top wall and a bottom wall opposite each other in its height direction, and an elastic member located on the inner side of the top wall. The elastic member includes a pressing plate and multiple support arms connected to four edges of the pressing plate. The multiple support arms extend obliquely away from the pressing plate relative to the height direction, and are adapted to suspend the pressing plate on an inner side of the top wall. The terminal board has a front end fixed to the inner side of the bottom wall of the terminal shell and a contact protrusion formed on the front surface of its front end. The elastic member and the contact protrusion are spaced opposite each other in the height direction and are adapted to clamp a mating terminal inserted therebetween to achieve electrical connection between the terminal board and the mating terminal. The pressing plate of the elastic member is adapted to press against the mating terminal to ensure reliable electrical contact between the mating terminal and the contact protrusion on the terminal board.

### BRIEF DESCRIPTION OF DRAWINGS

The above and other features of the present invention will become more apparent by describing in detail exemplary embodiments thereof with reference to the accompanying drawings, in which:

FIG. 1 shows an illustrative perspective view of a terminal according to an exemplary embodiment of the present invention;

FIG. 2 shows an illustrative exploded view of a terminal according to an exemplary embodiment of the present invention;

FIG. 3 shows a longitudinal sectional view of a terminal according to an exemplary embodiment of the present invention;

FIG. 4 shows a horizontal sectional view of a terminal according to an exemplary embodiment of the present invention, wherein the bottom wall of the terminal shell and the terminal plate are shown;

FIG. 5 shows an illustrative perspective view of a terminal shell according to an exemplary embodiment of the present invention;

FIG. 6 shows a horizontal sectional view of a terminal shell according to an exemplary embodiment of the present invention, wherein the top wall and elastic member of the terminal shell are shown;

FIG. 7 shows a longitudinal sectional view of a terminal shell according to an exemplary embodiment of the present invention; and

FIG. 8 shows an illustrative view of terminal and mating terminal mating according to an exemplary embodiment of the present invention.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, a terminal comprises: a terminal shell having a top wall and a bottom wall opposite each other in its height direction, and an elastic member located on the inner side of the top wall; and a terminal board which has a front end fixed to the inner side of the bottom wall of the terminal shell and a contact protrusion formed on the front surface of its front end. The elastic member and the contact protrusion are spaced opposite each other in the height direction, and is adapted to clamp a mating terminal inserted between them, in order to achieve electrical connection between the terminal board and the mating terminal. The elastic member comprises a pressing plate and multiple support arms connected to the four edges of the pressing plate. The multiple support arms extend obliquely away from the pressing plate relative to the height direction, and are used to suspend the pressing plate on the inner side of the top wall. The pressing plate of the elastic member is used to press against the mating terminal to ensure reliable electrical contact between the mating terminal and the contact protrusion on the terminal board.

According to another embodiment, a connector comprises a connector housing, and the above terminal inserted into the connector housing.

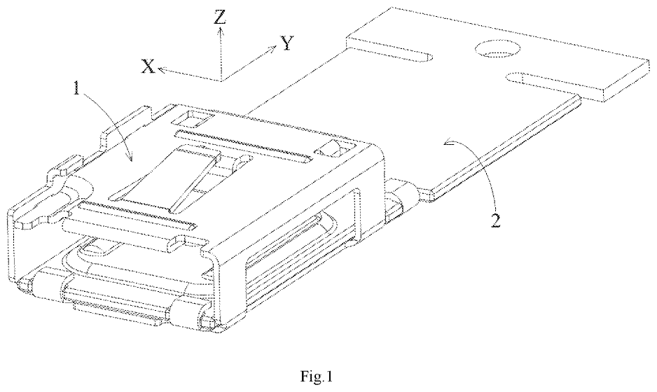

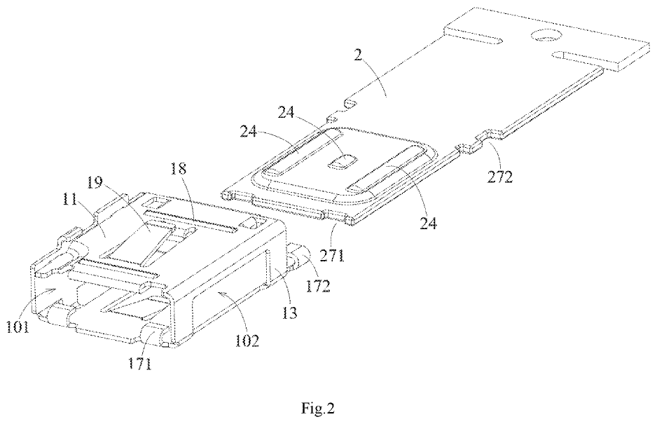

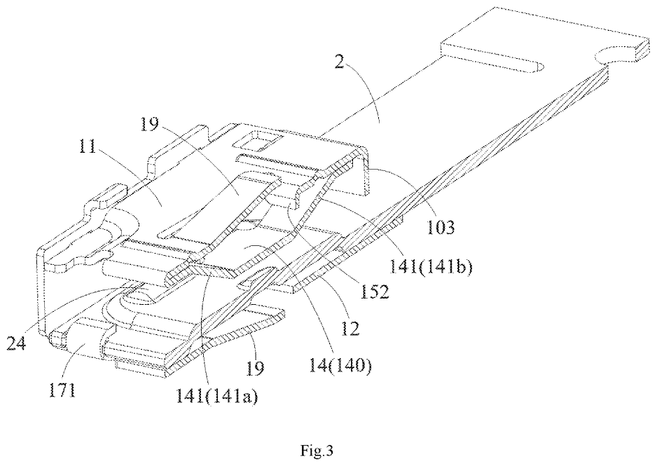

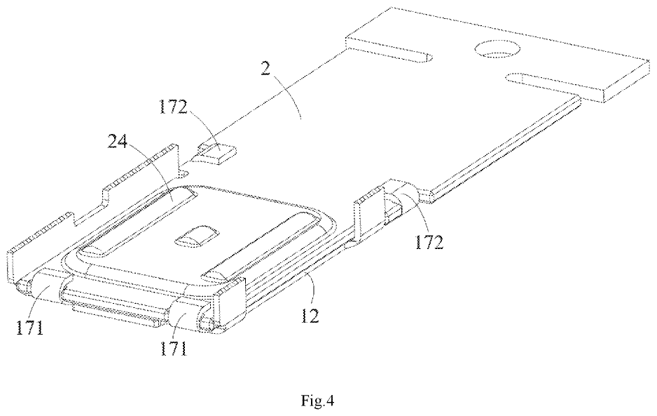

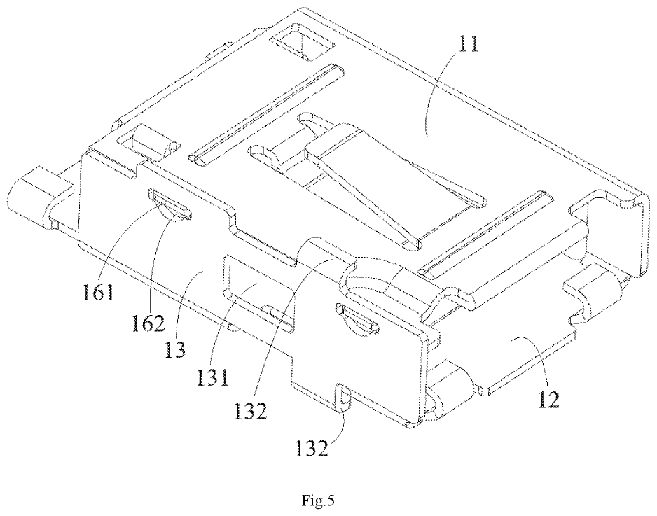

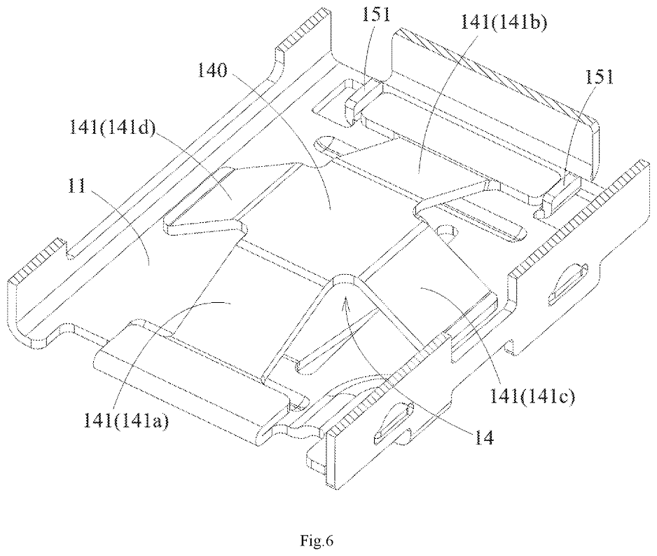

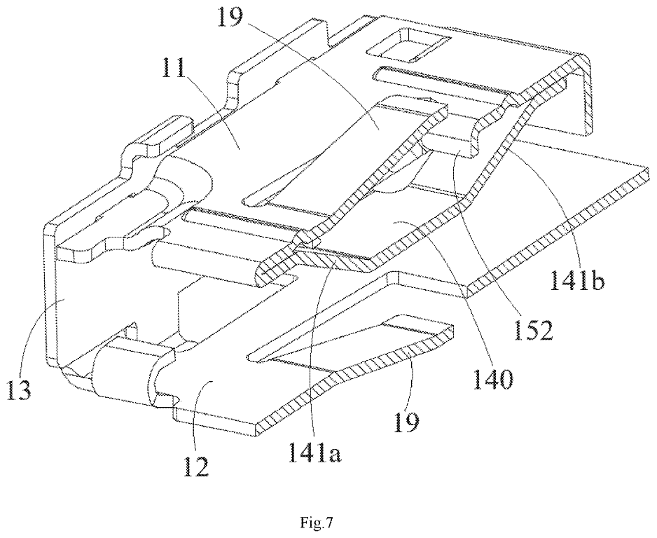

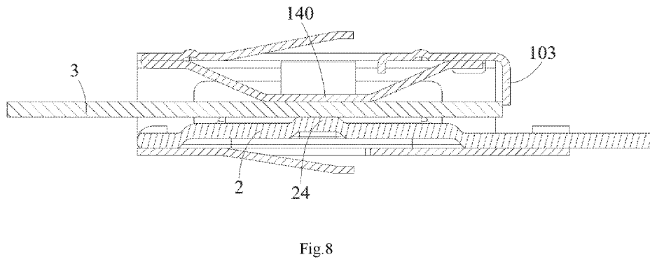

FIG. 1 shows an illustrative perspective view of a terminal according to an exemplary embodiment of the present invention. FIG. 2 shows an illustrative exploded view of a terminal according to an exemplary embodiment of the present invention. FIG. 3 shows a longitudinal sectional view of a terminal according to an exemplary embodiment of the present invention. FIG. 4 shows a horizontal sectional view of a terminal according to an exemplary embodiment of the present invention, wherein the bottom wall 12 of the terminal shell 1 and the terminal plate 2 are shown. FIG. 5 shows an illustrative perspective view of a terminal shell 1 according to an exemplary embodiment of the present invention. FIG. 6 shows a horizontal sectional view of a terminal shell 1 according to an exemplary embodiment of the present invention, wherein the top wall 11 and elastic member 14 of the terminal shell 1 are shown. FIG. 7 shows a longitudinal sectional view of a terminal shell 1 according to an exemplary embodiment of the present invention. FIG. 8 shows an illustrative view of terminal and mating terminal 3 mating according to an exemplary embodiment of the present invention.

As shown in FIGS. 1-8, in an exemplary embodiment of the present invention, a terminal is disclosed. The terminal includes: a terminal shell 1 and a terminal board 2. The terminal shell 1 has a top wall 11 and a bottom wall 12 that are opposite in its height direction Z, as well as an elastic member 14 located on the inner side of the top wall 11. The front end of terminal board 2 is fixed to the inner side of the bottom wall 12 of terminal shell 1. A contact protrusion 24 is formed on the front end of terminal board 2. The elastic member 14 and the contact protrusion 24 are spaced opposite each other in the height direction Z, used to clamp the mating terminal 3 inserted between them, in order to achieve electrical connection between the terminal board 2 and the mating terminal 3. The elastic member 14 includes a pressing plate 140 and multiple support arms 141 connected to the four edges of the pressing plate 140. The multiple support arms 141 extend obliquely away from the pressing plate 140 with respect to the height direction Z, and are used to suspend the pressing plate 140 on the inner side of the top wall 11. The pressing plate 140 of the elastic component 14 is used to press against the mating terminal 3, ensuring reliable electrical contact between the mating terminal 3 and the contact protrusion 24 on the terminal board 2.

The pressing plate 140 is in a horizontal plate shape perpendicular to the height direction Z, and is adapted to press against the top surface of the inserted mating terminal 3 to ensure that the inserted mating terminal 3 is in a horizontal posture perpendicular to the height direction Z.

Multiple support arms 141 are evenly spaced around the periphery of the pressing plate 140. The multiple support arms 141 include front and rear support arms 141a and 141b that are opposite in the longitudinal direction Y of the terminal shell 1, as well as left and right support arms 141c and 141d that are opposite in the transverse direction X of the terminal shell 1. The end of the front support arm 141a is connected to the top wall 11. The ends of the rear support arm 141b, left support arm 141c, and right support arm 141d are supported on the inner side of the top wall 11 in a movable manner.

Two first limiting pieces 151 are formed on the inner side of the top wall 11 at intervals opposite to each other in the transverse direction X. The two first limiting pieces 151 are respectively pressed against the left and right sides of the end of the rear support arm 141b to prevent the rear support arm 141b from being moved in the transverse direction X. A second limiting piece 152 is formed on the inner side of the top wall 11 of the terminal shell 1. The second limiting piece 152 is pressed against the upper side of the rear support arm 141b to prevent excessive deformation of the rear support arm 141b.

The terminal shell 1 has a front opening 101 to allow the mating terminal 3 to be inserted along the longitudinal direction Y of the terminal shell 1 through the front opening 101. The terminal shell 1 also has a rear limiting wall 103 longitudinally opposite the front opening 101, which is used to rest against the end face of the inserted mating terminal 3 to longitudinally position the mating terminal 3.

The terminal shell 1 has two opposite side walls 13 in its transverse direction X. A side opening 102 is formed on one side wall 13 of the terminal shell 1 to allow the mating terminal 3 to be inserted along the transverse direction X of the terminal shell 1 through the side opening 102. The other side wall 13 of the terminal shell 1 is used to rest against the end face of the inserted mating terminal 3, in order to position the inserted mating terminal 3 in the transverse direction X.

Multiple contact protrusions 24 are formed on the front end of the terminal board 2, which extend along the longitudinal direction Y of the terminal shell 1 and are spaced apart in the transverse direction X of the terminal shell 1. In the illustrated embodiment, three contact protrusions 24 are formed on the front end of the terminal board 2. The longitudinal extension length of the middle contact protrusion 24 among the three contact protrusions 24 is smaller than that of the other two contact protrusions 24, and the other two contact protrusions 24 are symmetrically arranged on both sides of the middle contact protrusion 24.

The top wall 11 of the terminal shell 1 has two opposite side edges in the transverse direction X. One side edge of the top wall 11 is connected to one side wall 13 of the terminal shell 1, and the other side edge of the top wall 11 is welded to the other side wall 13 of the terminal shell 1. Multiple tongues 161 are formed on the other side edge of the top wall 11, and multiple slots 162 corresponding to the multiple tongues 161 are formed on the other side wall 13 of the terminal shell 1. The multiple tongues 161 are respectively inserted into the multiple slots 162.

A slot hole 131 is formed in the other side wall 13 of the terminal shell 1, and an L-shaped bending piece 132 is formed on the upper and/or lower side of the other side wall 13 of the terminal shell 1. The slot hole 131 and bending piece 132 on the other side wall 13 of the terminal shell 1 are used to engage with a locking piece inside a connector housing to lock the terminal in the connector housing.

A first rivet piece 171 is formed on the front side edge of the bottom wall 12 of the terminal shell 1, and a first recess 271 corresponding to the first rivet piece 171 is formed on the front side edge of the terminal board 2. The first rivet piece 171 is positioned in the first recess 271 and bent and riveted to the terminal board 2. On the opposite sides of the bottom wall 12 of the terminal shell 1 in the transverse direction X, second rivet pieces 172 are respectively formed. On the opposite sides of the terminal board 2 in the transverse direction, second notches 272 corresponding to the second rivet pieces 172 are respectively formed. The second rivet pieces 172 are positioned in the second notches 272 and bent and riveted to the terminal board 2.

A locking spring 19 is formed on the top wall 11 and/or bottom wall 12 of the terminal shell 1. The locking spring 19 extends obliquely towards the outside of the terminal shell 1 for engagement with the connector housing to lock the terminal in the connector housing.

Reinforcing ribs 18 are formed on the top wall 11 and/or bottom wall 12 of the terminal shell 1, and the reinforcing ribs 18 extend along the transverse direction X of the terminal shell 1 to enhance the strength of the top wall 11 and/or bottom wall 12 of the terminal shell 1.

In the illustrated embodiment, the terminal shell 1 is a one-piece stamped part. This can reduce manufacturing costs and improve production efficiency.

The terminal board 2 is a copper plate or copper alloy plate used for conducting current and for electrical connection with the mating terminal 3. The terminal shell 1 is a steel shell, and the elastic member 14 of terminal shell 1 is used to apply a predetermined pressing force on the mating terminal 3 to ensure reliable electrical contact between the mating terminal 3 and the terminal board 2.

In another exemplary embodiment of the present invention, a connector is also disclosed. The connector includes a connector housing and the above terminal. The terminal is inserted into the connector housing.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A terminal, comprising:
a terminal shell having a top wall and a bottom wall opposite each other in its height direction, and an elastic member located on the inner side of the top wall, elastic member includes a pressing plate and multiple support arms connected to four edges of the pressing plate, the multiple support arms extend obliquely away from the pressing plate relative to the height direction, and are adapted to suspend the pressing plate on an inner side of the top wall; and
a terminal board which has a front end fixed to the inner side of the bottom wall of the terminal shell and a contact protrusion formed on the front surface of its front end, wherein:
the elastic member and the contact protrusion are spaced opposite each other in the height direction and are adapted to clamp a mating terminal inserted therebetween to achieve electrical connection between the terminal board and the mating terminal; and
the pressing plate of the elastic member is adapted to press against the mating terminal to ensure reliable electrical contact between the mating terminal and the contact protrusion on the terminal board.

2. The terminal according to claim 1, wherein the pressing plate is in a horizontal plate shape perpendicular to the height direction, and is adapted to be attached to the top surface of the inserted mating terminal to ensure that the inserted mating terminal is in a horizontal posture perpendicular to the height direction.

3. The terminal according to claim 1, wherein the multiple support arms are evenly spaced around the perimeter of the pressing plate.

4. The terminal according to claim 1, wherein the multiple support arms include a front support arm and a rear support arm that are opposite in the longitudinal direction of the terminal shell, and a left support arm and a right support arm that are opposite in the transverse direction of the terminal shell.

5. The terminal according to claim 4, wherein the end of the front support arm is connected to the top wall, and the ends of the rear support arm, left support arm, and right support arm are supported on the inner side of the top wall in a movable manner.

6. The terminal according to claim 5, wherein two first limiting pieces spaced opposite each other in the transverse direction are formed on the inner side of the top wall, the two first limiting pieces respectively rest on the left and right sides of the end of the rear support arm to prevent the rear support arm from being moved in the transverse direction.

7. The terminal according to claim 5, wherein a second limiting piece is formed on the inner side of the top wall of the terminal shell, and the second limiting piece is pressed against the upper side of the rear support arm to prevent excessive deformation of the rear support arm.

8. The terminal according to claim 1, wherein:
the terminal shell has a front opening to allow the mating terminal to be inserted through the front opening along the longitudinal direction of the terminal shell; and
the terminal shell has a rear limiting wall longitudinally opposite to the front opening and is adapted to rest against the end face of the inserted mating terminal to longitudinally position the mating terminal.

9. The terminal according to claim 8, wherein:
the terminal shell has two opposite side walls in its transverse direction, and a side opening is formed on one side wall of the terminal shell to allow the mating terminal to be inserted along the transverse direction of the terminal shell through the side opening; and
the other side wall of the terminal shell is adapted to rest against the end face of the inserted mating terminal to position the inserted mating terminal in the transverse direction.

10. The terminal according to claim 9, wherein multiple contact protrusions are formed on the front end of the terminal board and extend along the longitudinal direction of the terminal shell and are spaced apart in the transverse direction of the terminal shell.

11. The terminal according to claim 10, wherein three contact protrusions are formed on the front end of the terminal board, and the longitudinal extension length of the middle contact protrusion among the three contact protrusions is less than the longitudinal extension length of the other two contact protrusions, and the other two contact protrusions are symmetrically arranged on both sides of the middle contact protrusion.

12. The terminal according to claim 9, wherein the top wall of the terminal shell has two opposite side edges in the transverse direction, one side edge of the top wall is connected to one side wall of the terminal shell, and the other side edge of the top wall is welded to the other side wall of the terminal shell.

13. The terminal according to claim 12, wherein multiple tongues are formed on the other side edge of the top wall, and multiple slots corresponding to the multiple tongues are formed on the other side wall of the terminal shell, the multiple tongues are respectively inserted into the multiple slots.

14. The terminal according to claim 9, wherein a slot hole is formed in the other side wall of the terminal shell, and an L-shaped bending piece is formed on the upper and/or lower side edge of the other side wall of the terminal shell, the slot hole and bending piece on the other side wall of the terminal shell are used to engage with a locking piece inside a connector housing to lock the terminal in the connector housing.

15. The terminal according to claim 1, wherein:
a first rivet piece is formed on the front side edge of the bottom wall of the terminal shell, and a first recess corresponding to the first rivet piece is formed on the front side edge of the terminal board, the first rivet piece is positioned in the first recess and bent and riveted to the terminal board;
second rivet pieces are respectively formed on opposite sides of the bottom wall of the terminal shell in the transverse direction, and second notches corresponding to the second rivet pieces are respectively formed on opposite sides of the terminal board in the transverse direction, the second rivet pieces are respectively positioned in the second notches and bent and riveted to the terminal board.

16. The terminal according to claim 1, wherein a locking spring is formed on the top wall and/or bottom wall of the terminal shell and extends obliquely towards the outside of the terminal shell for engagement with a connector housing to lock the terminal in the connector housing.

17. The terminal according to claim 1, wherein a reinforcing rib is formed on the top wall and/or bottom wall of the terminal shell and extends along the transverse direction of the terminal shell to enhance the strength of the top wall and/or bottom wall of the terminal shell.

18. The terminal according to claim 1, wherein the terminal shell is an integral stamped part.

19. The terminal according to claim 1, wherein the terminal board is a copper plate or copper alloy plate used for conducting current and for electrical connection with the mating terminal.

20. The terminal according to claim 1, wherein the terminal shell is a steel shell, and the elastic member of the terminal shell is adapted to apply a predetermined pressing force on the mating terminal to ensure reliable electrical contact between the mating terminal and the terminal board.
